(19) United States
(12) Patent Application Publication
(10) Pub. No.: US 2018/0072292 A1
(43) Pub. Date: Mar. 15, 2018

(54) VEHICLE AUTOMATIC EMERGENCY BRAKING SYSTEM

(71) Applicant: MAGNA ELECTRONICS INC., Auburn Hills, MI (US)

(72) Inventor: Ronald R. Renaud, Oxford, MI (US)

(21) Appl. No.: 15/697,804

(22) Filed: Sep. 7, 2017

Related U.S. Application Data
(60) Provisional application No. 62/385,407, filed on Sep. 9, 2016.

(51) Int. Cl. B60T 8/92

(52) U.S. Cl. CPC B60T 8/92; B60T 7/12

(57) ABSTRACT

An automatic braking system of a vehicle includes an auxiliary braking device at at least two wheels of the vehicle. A controller is operable to control the auxiliary braking devices responsive to an input from a brake fluid pressure sensor and an input from a brake pedal position sensor. Responsive to the inputs being indicative of a brake pedal of the vehicle being applied and a brake fluid pressure of brake fluid of a hydraulic brake system of the vehicle being below a threshold level for the degree of application of the brake pedal, the controller determines that there is at least a partial failure of the hydraulic brake system of the vehicle and controls the auxiliary braking devices to slow down the vehicle.

### CROSS REFERENCE TO RELATED APPLICATION

The present application claims the filing benefits of U.S. provisional application Ser. No. 62/385,407, filed Sep. 9, 2016, which is hereby incorporated herein by reference in its entirety.

### FIELD OF THE INVENTION

The present invention relates generally to a vehicle braking system for a vehicle and, more particularly, to a vehicle emergency braking system.

### BACKGROUND OF THE INVENTION

Brake systems for vehicles are typically hydraulic brake systems. Over years of use, the hydraulic braking systems may not be very well maintained and the metal parts may rust and the rubber flexible lines may fail. If pressure is lost in the system, the brakes will not work and the driver may be faced with a situation where the driver has to manually downshift the vehicle transmission and/or manually apply the parking brake of the vehicle (typically only at the rear wheels) in order to slow down and stop the vehicle. All this may have to be done while the driver is also steering the vehicle to avoid traffic or obstacles in the path of the brakeless vehicle.

### SUMMARY OF THE INVENTION

The present invention provides a driver assistance system or automatic braking system for a vehicle that is operable to automatically control or downshift the vehicle transmission and/or apply the vehicle parking brake or other auxiliary brake when a failure in the hydraulic (primary) brake system is determined.

In accordance with an aspect of the present invention, the automatic braking system includes a controller that controls an auxiliary braking device at each wheel (or at at least two wheels) of a vehicle equipped with the automatic braking system. The controller is operable to control the auxiliary braking devices responsive to an input from a brake fluid pressure sensor and an input from a brake pedal position sensor (and optionally responsive to inputs from an accelerator pedal position sensor (or engine RPM sensor), vehicle speed sensor and/or steering wheel position sensor and/or the like). Responsive to the inputs being indicative of a brake pedal of the vehicle being applied and a brake fluid pressure of brake fluid of a hydraulic brake system of the vehicle being below a threshold level for the degree of application of the brake pedal, the controller determines that there is at least a partial failure of the hydraulic brake system of the vehicle and controls the auxiliary braking devices to slow down the vehicle. The controller may also control a transmission of the vehicle to downshift the transmission to assist in slowing down the vehicle and/or the controller may also control the engine of the vehicle to reduce the RPMs of the engine to assist in slowing down the vehicle. The auxiliary braking devices may comprise electromechanical braking devices, such as electronically controlled brake calipers.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with an emergency braking system in accordance with the present invention; and

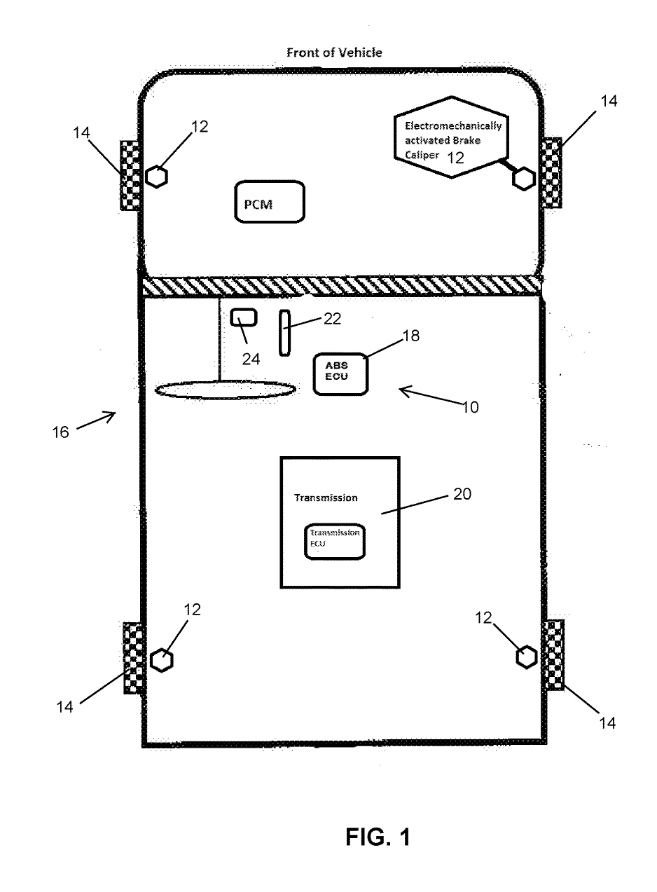

FIG. 2 is a block diagram of the emergency braking system of the present invention.

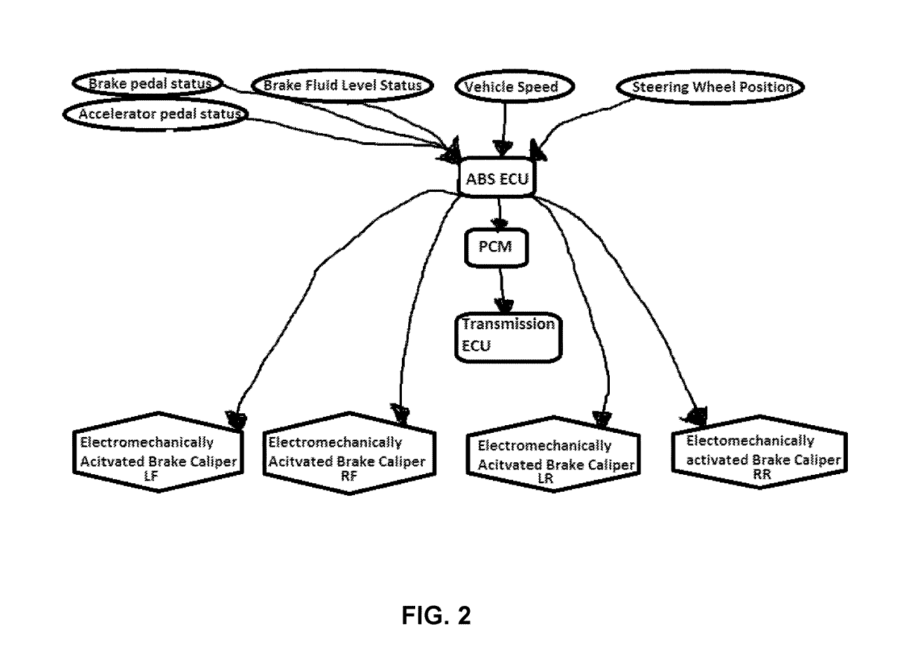

### DESCRIPTION OF THE PREFERRED EMBODIMENTS

The vehicle driver assist system and/or emergency braking system operates to control braking or slowing of a vehicle when the system determines that there is a failure or partial failure of the primary or hydraulic braking system of the vehicle. The braking system involves the use of an electric parking brake and/or emergency brake of the vehicle in a new way and a software strategy for using the transmission to decelerate the vehicle when an emergency failure of the hydraulic braking system occurs.

Referring now to the drawings and the illustrative embodiments depicted therein, the braking system 10 comprises an electromechanical brake device or caliper 12 disposed at each wheel 14 of the vehicle 16 (and operable to brake or slow rotation of the respective wheel) and a controller 18. The controller 18 is operable to actuate or control the electromechanical brake devices 12 responsive to a determination that the primary or hydraulic brake system of the vehicle has a failure or partial failure. The braking system 10 may also control the transmission 20 of the vehicle to downshift the transmission to assist in slowing the vehicle responsive to the determination that the primary or hydraulic brake system of the vehicle has a failure or partial failure.

The system involves the use of the electric parking brake and/or emergency brake when a hydraulic system fails (with the failure being sensed by pressure sensors and/or the fluid level sensor, along with inputs from the accelerator pedal 22 and brake pedal 24 positions), and automatically applies the auxiliary brake system with varying amount of application (braking force) according to the brake pedal sensor input. Once the automatic emergency electric brake system has determined that there is an event of hydraulic brake fluid pressure failure (such as when the pressure in one or more of the brake lines falls below a threshold level when the brake pedal is applied, which would be indicative of a leak or caliper failure or the like in the hydraulic brake system) and is applying the auxiliary or electric brake, the software of the system also (optionally simultaneously) begins the downshifting of the transmission to a lower gear to assist in the emergency slowing and stopping of the vehicle.

The automatic emergency auxiliary brake may comprise an electrically activated servo or actuator (mechanical/electromechanical) at the brake calipers at all four of the wheel locations. The controller may independently operate or actuate each auxiliary brake device (or may operate them together) to apply what that individual wheel would need to slow the vehicle without wheel lock up. Optionally, the auxiliary brake devices may be disposed at two wheels of the vehicle, such as at the front wheels or at the rear wheels. Preferably, an auxiliary brake device is disposed at each of the four wheels of the vehicle to enhance braking and control of the vehicle during operation of the auxiliary braking system.

Thus, when a failure of the hydraulic brake system occurs, such as from issues such as metal line or flexible line failure or caliper failure or any other forms of failure or partial failure where the primary braking system is unable to sufficiently reduce the speed of the vehicle or complete a stop of the vehicle, the emergency auxiliary brake system engage its strategy and components. For example, a first indication or input to the system may be a signal or output from a brake pedal travel sensor traveling to a lower status point than was stored as a normal brake position when braking normally, and the system may also (simultaneously) receive an indication or input indicative of a sensor determining that the brake fluid pressure is at or below a threshold lower level (such as a pressure level below a level at which the fluid pressure should be or is expected to be for that amount of brake pedal travel). The system may also receive an input pertaining to the vehicle speed and an input pertaining to the accelerator pedal status to determine if the condition is a failure to slow the vehicle. For example, if the accelerator pedal is still depressed, it is not likely that the driver is trying to slow the vehicle, so the system may only activate to apply the auxiliary brake in situations where the accelerator pedal is not depressed. The system, responsive to a determination that the driver is trying to slow the vehicle but the primary braking system is failing, would begin a series in parallel of control actions of shifting the transmission gear to a lower gear, reducing the RPM of the vehicle engine, and engaging the electromechanically activated brake calipers (auxiliary brake) in a proportional manner to reduce the speed of the vehicle while limiting or avoiding wheel lock up at any one wheel at any corner of the vehicle.

The braking system may thus be responsive to various vehicle inputs, such as a vehicle speed input, a vehicle acceleration input, a brake pedal status input, a brake fluid pressure level input, an accelerator pedal status input, and/or the like. The vehicle inputs may be provided to the controller via a communication bus of the vehicle (such as a CAN bus or the like). The controller, responsive to the inputs, processes the inputs to determine if a primary brake system failure is occurring and may, responsive to such determination, controls the engine and/or transmission and/or actuates/controls an auxiliary brake system to reduce the speed of vehicle.

Optionally, responsive to determination of primary brake failure, the system may, in addition to controlling the auxiliary brake(s) and/or engine and/or transmission, may also control steering to assist in collision avoidance (in situations where the driver may not react in time upon realization that the vehicle brakes are not working). For example, the system may utilize aspects of the collision avoidance systems described in U.S. Pat. Nos. 9,260,095; 9,092,986; 9,090,234; 8,013,780; 7,123,168; 6,850,156; 6,534,884 and/or 5,670,935, and/or U.S. Publication Nos. US-2016-2016-0210853, US-2016-0075332, US-2014-0309884, US-2014-0067206 and/or US-2012-0218412, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or 4G or 5G) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096: US-2015-0352953; US-2016-0036917 and/or US-2016-0210853, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. An automatic braking system of a vehicle, said automatic braking system comprising:
an auxiliary braking device at at least two wheels of a vehicle equipped with said automatic braking system;
a controller, wherein said controller is operable to control said auxiliary braking devices responsive to an input from a brake fluid pressure sensor and an input from a brake pedal position sensor; and
wherein, responsive to said inputs being indicative of a brake pedal of the equipped vehicle being applied and a brake fluid pressure of brake fluid of a hydraulic brake system of the equipped vehicle being below a threshold level for the degree of application of the brake pedal, said controller determines that there is at least a partial failure of the hydraulic brake system of the equipped vehicle and controls said auxiliary braking devices to slow the vehicle.

2. The automatic braking system of claim 1, wherein said controller, responsive to determination that there is at least a partial failure of the hydraulic brake system of the equipped vehicle, controls a transmission of the vehicle to shift the transmission to a lower gear to assist in slowing the equipped vehicle.

3. The automatic braking system of claim 1, wherein said controller, responsive to determination that there is at least a partial failure of the hydraulic brake system of the equipped vehicle, controls an engine of the vehicle to reduce the RPMs of the engine to assist in slowing the equipped vehicle.

4. The automatic braking system of claim 1, wherein said controller determines that there is at least a partial failure of the hydraulic brake system of the equipped vehicle at least in part responsive to an accelerator pedal status input.

5. The automatic braking system of claim 1, wherein said controller determines that there is at least a partial failure of the hydraulic brake system of the equipped vehicle at least in part responsive to a vehicle speed input.

6. The automatic braking system of claim 1, wherein said controller determines that there is at least a partial failure of the hydraulic brake system of the equipped vehicle at least in part responsive to a steering wheel position input.

7. The automatic braking system of claim 1, wherein said auxiliary braking devices comprise electromechanical braking devices.

8. The automatic braking system of claim 7, wherein said electromechanical braking devices comprise electronically controlled brake calipers.

9. The automatic braking device of claim 1, wherein an auxiliary braking device is disposed at each wheel of the equipped vehicle.

10. The automatic braking system of claim 1, wherein said auxiliary braking devices comprise part of a parking brake system of the equipped vehicle.

11. An automatic braking system of a vehicle, said automatic braking system comprising:
an auxiliary braking device at at least two wheels of a vehicle equipped with said automatic braking system;
a controller, wherein said controller is operable to control said auxiliary braking devices responsive to an input from a brake fluid pressure sensor and an input from a brake pedal position sensor;
wherein, responsive to said inputs being indicative of a brake pedal of the equipped vehicle being applied and a brake fluid pressure of brake fluid of a hydraulic brake system of the equipped vehicle being below a threshold level for the degree of application of the brake pedal, said controller determines that there is at least a partial failure of the hydraulic brake system of the equipped vehicle and controls said auxiliary braking devices to slow the vehicle;
wherein said controller, responsive to determination that there is at least a partial failure of the hydraulic brake system of the equipped vehicle, controls a transmission of the vehicle to shift the transmission to a lower gear to assist in slowing the equipped vehicle; and
wherein said controller, responsive to determination that there is at least a partial failure of the hydraulic brake system of the equipped vehicle, controls an engine of the vehicle to reduce the RPMs of the engine to assist in slowing the equipped vehicle.

12. The automatic braking system of claim 11, wherein said controller determines that there is at least a partial failure of the hydraulic brake system of the equipped vehicle at least in part responsive to an accelerator pedal status input.

13. The automatic braking system of claim 11, wherein said controller determines that there is at least a partial failure of the hydraulic brake system of the equipped vehicle at least in part responsive to a vehicle speed input.

14. The automatic braking system of claim 11, wherein said controller determines that there is at least a partial failure of the hydraulic brake system of the equipped vehicle at least in part responsive to a steering wheel position input.

15. The automatic braking device of claim 11, wherein an auxiliary braking device is disposed at each wheel of the equipped vehicle.

16. An automatic braking system of a vehicle, said automatic braking system comprising:
an auxiliary braking device at at least two wheels of a vehicle equipped with said automatic braking system;
wherein said auxiliary braking devices comprise electromechanical braking devices;
a controller, wherein said controller is operable to control said auxiliary braking devices responsive to an input from a brake fluid pressure sensor and an input from a brake pedal position sensor;
wherein, responsive to said inputs being indicative of a brake pedal of the equipped vehicle being applied and a brake fluid pressure of brake fluid of a hydraulic brake system of the equipped vehicle being below a threshold level for the degree of application of the brake pedal, said controller determines that there is at least a partial failure of the hydraulic brake system of the equipped vehicle and controls said auxiliary braking devices to slow the vehicle; and
wherein said controller determines that there is at least a partial failure of the hydraulic brake system of the equipped vehicle at least in part responsive to at least one of (i) an accelerator pedal status input, (ii) a vehicle speed input and (iii) a steering wheel position input.

17. The automatic braking system of claim 16, wherein said controller, responsive to determination that there is at least a partial failure of the hydraulic brake system of the equipped vehicle, controls a transmission of the vehicle to shift the transmission to a lower gear to assist in slowing the equipped vehicle.

18. The automatic braking system of claim 16, wherein said controller, responsive to determination that there is at least a partial failure of the hydraulic brake system of the equipped vehicle, controls an engine of the vehicle to reduce the RPMs of the engine to assist in slowing the equipped vehicle.

19. The automatic braking device of claim 16, wherein an auxiliary braking device is disposed at each wheel of the equipped vehicle.

20. The automatic braking system of claim 16, wherein said auxiliary braking devices comprise part of a parking brake system of the equipped vehicle.
